(19) United States
(12) Patent Application Publication
(10) Pub. No.: US 2026/0279223 A1
(43) Pub. Date: Sep. 17, 2026

(54) METHOD FOR GENERATING GRADING DATA FOR CODING TEST, DEVICE FOR GENERATING GRADING DATA, AND SYSTEM FOR GENERATING GRADING DATA

(71) Applicant: Branch and Bound Co., Ltd., Seoul (KR)

(72) Inventors: Seung Yong Lee, Seoul (KR); Dong Hyun Kim, Seoul (KR); Tae Yang Kim, Seoul (KR); Hyung Jin Kim, Seoul (KR); Gyo Jun Youn, Seoul (KR); Sang Hun Lee, Seoul (KR); Jae Hwi Kim, Seoul (KR)

(73) Assignee: Branch and Bound Co., Ltd., Seoul (KR)

(21) Appl. No.: 19/529,302

(22) Filed: Feb. 4, 2026

(30) Foreign Application Priority Data
Feb. 12, 2025 (KR) 10-2025-0017714

(51) Int. Cl. G09B 19/00; G06F 8/71; G06N 3/045

(52) U.S. Cl. CPC G09B 19/0053; G06F 8/71; G06N 3/045

(57) ABSTRACT

Provided are a method for generating grading data for a coding test, a device for generating grading data, and a system for generating grading data. The method for generating grading data for a coding test includes receiving a problem through a user interface, generating a plurality of problem information based on the problem using a first neural network, generating an input data generator for the problem based on the plurality of problem information using a second neural network, executing the input data generator to generate test input data for the problem, generating a solution code for the problem based on the plurality of problem information using a third neural network, and generating test output data for the test input data based on the solution code to generating grading data.

### CROSS REFERENCE TO RELATED APPLICATION

This application claims priority to and the benefit of Korean Patent Application No. 10-2025-0017714 filed in the Korean Intellectual Property Office on Feb. 12, 2025, the entire contents of which are incorporated herein by reference.

### TECHNICAL FIELD

The present disclosure relates to a method for generating grading data for a coding test, a device for generating grading data, and a system for generating grading data.

### BACKGROUND OF THE INVENTION

In general, coding refers to a process of inputting instructions in programming languages that can be understood by computers, such as C language, Java, Python, and the like. Since all technologies representing the fourth industrial revolution era, including artificial intelligence, Internet of Things, intelligent robots, big data analysis and utilization, are implemented through software based on Information and Communication Technology(ICT), various entities such as companies and educational institutions utilize coding tests to evaluate coding capabilities of test subjects or conduct coding education. Therefore, there is a need to secure a large quantity of high-quality problems in order to meaningfully distinguish and provide feedback on the coding capabilities of test subjects.

Test cases are needed for scoring in order for an evaluator to score and evaluate code written by a test subject. However, since the format and conditions of test cases differ for each problem, considerable time and resources are invested in creating, verifying, and validating test cases for producing a single problem.

### SUMMARY OF THE INVENTION

An embodiment is to provide a method for generating grading data for a coding test, a device for generating grading data, and a system for generating grading data, which automatically generate grading data for each problem.

An embodiment is to provide a method for generating grading data for a coding test, a device for generating grading data, and a system for generating grading data, which generate reliable grading data and solution code.

However, the problems to be solved by the present disclosure are not limited to those mentioned above, and may include problems that are not mentioned but can be clearly understood by a person having ordinary skill in the art to which the present disclosure belongs from the description below.

In order to solve such a technical problem, a method for generating grading data for a coding test according to an embodiment includes receiving a problem through a user interface, generating a plurality of problem information based on the problem using a first neural network, generating an input data generator for the problem based on the plurality of problem information using a second neural network, executing the input data generator to generate test input data for the problem, generating a solution code for the problem based on the plurality of problem information using a third neural network, and generating test output data for the test input data based on the solution code to generating grading data.

A device for generating grading data according to an embodiment includes: a processor; an accelerator; and a memory, and wherein the processor is configured to execute a program stored in the memory to perform to: receive a problem through a user interface, generate a plurality of problem information based on the problem using a first neural network computed by the accelerator, generate an input data generator for the problem based on the plurality of problem information using a second neural network computed by the accelerator, execute the input data generator to generate test input data for the problem, generate a solution code for the problem based on the plurality of problem information using a third neural network computed by the accelerator, and generate test output data for the test input data based on the solution code to generating grading data.

A system for generating grading data according to an embodiment includes: a problem information extraction module configured to receive a problem and generate a plurality of problem information based on the problem, an input data generator generation module configured to generate an input data generator configured to generate test input data for the problem based on the plurality of problem information, a validator generation module configured to generate a validator verifying validity of the test input data based on the plurality of problem information, and a solution code generation module configured to generate a solution code for the problem based on the plurality of problem information.

### BRIEF DESCRIPTION OF THE DRAWINGS

FIG. 1 is a diagram for describing a method of grading a user code written by a test subject and grading data.

FIG. 2 is a block diagram illustrating a device for generating grading data according to an embodiment.

FIG. 3 is a block diagram illustrating a system for generating grading data according to an embodiment.

FIG. 4 is a diagram for describing an exemplary structure of a language model neural network according to an embodiment.

FIG. 5 is a diagram for describing an input data generator, a validator, and a solution code according to an embodiment.

FIG. 6 is a flowchart illustrating a method for generating grading data according to an embodiment.

FIGS. 7 and 8 are diagrams for describing a method for generating grading data according to an embodiment.

FIGS. 9 to 11 are diagrams illustrating a system for generating grading data according to an embodiment.

### DETAILED DESCRIPTION OF THE INVENTION

Hereinbelow, embodiments of the present disclosure will be described in detail with reference to the accompanying drawings so that those skilled in the art to which the present disclosure pertains can easily implement the embodiments. However, the present disclosure may be implemented in various different forms and is not limited to the embodiments described herein. In addition, in the drawings, in order to clearly describe the present disclosure, a part not related to the description is omitted and like reference numerals designate like elements throughout the specification.

Throughout the specification, when a part is said to “include” a component, this means that it may further include other components rather than excluding other components, unless specifically stated to the contrary.

In the present disclosure, each of phrases such as “A or B”, “at least one of A and B”, “at least one of A or B”, “A, B, or C”, “at least one of A, B, and C”, and “at least one of A, B, or C” may include any one or all possible combinations of items listed together with a corresponding phrase among the phrases.

In the present disclosure, the expression described by the singular form can be interpreted as a singular or plural, unless an explicit expression such as “one” or “single” is used.

In the present disclosure, ““and/or”” includes each and every combination of one or more of the mentioned constituent elements.

In the present disclosure, terms including an ordinary number, such as first and second, may be used for describing various constituent elements, but the constituent elements are not limited by the terms. The terms are used only to discriminate one constituent element from another constituent element. For example, a first constituent element may be referred to as a second constituent element, and similarly, the second constituent element may be referred to as the first constituent element without departing from the scope of the present disclosure.

In the present disclosure, in the flowchart described with reference to the drawings, the order of operations may be changed, multiple operations may be merged, or any operation may be divided, and a specific operation may not be performed.

Terms such as “module”, “unit”, “part”, etc., used in the present disclosure are terms to refer to a constituent element that performs at least one function or operation, and such constituent element may be implemented as hardware or software, or implemented by a combination of hardware and software. For example, the module may be a procedure executed on a processor, the processor, an object, an execution thread, a program, a dedicated circuit, and/or a computer, but is not limited thereto.

For example, both an application executed in a computing device and the computing device may be the modules. One or more modules may reside within the processor and/or an execution thread.

One module may be localized within one computer. One module may be distributed between two or more computers. Further, the modules may be executed by various computer-readable media having various data structures, which are stored therein. The modules may perform communication through local and/or remote processing according to a signal (for example, data transmitted from another system through a network, such as the Internet, through data and/or a signal from one module that interacts with other modules in a local system and a distribution system) having one or more data packets, for example.

An artificial intelligence model (AI model) executed in an artificial neural network of the present disclosure is a machine learning model that learns at least one task, and may be implemented as a computer program executed by a processor or an accelerator. A task learned by the artificial intelligence model may refer to a problem to be solved through machine learning or work to be performed through machine learning. The artificial intelligence model may be implemented as a computer program executed on a computing device, and may be downloaded over a network or sold in product form. Alternatively, the artificial intelligence model may interlock with various devices via a network.

In the present disclosure, a neural network, a computing model, a network function, and a neural network may be used as meanings which are interchangeable with one another. The neural network may be constituted by an aggregate of calculation units which may be generally called nodes or neurons and are interconnected to one another. The neural network may include at least one more nodes. The nodes constituting the neural networks may be interconnected by one or more links.

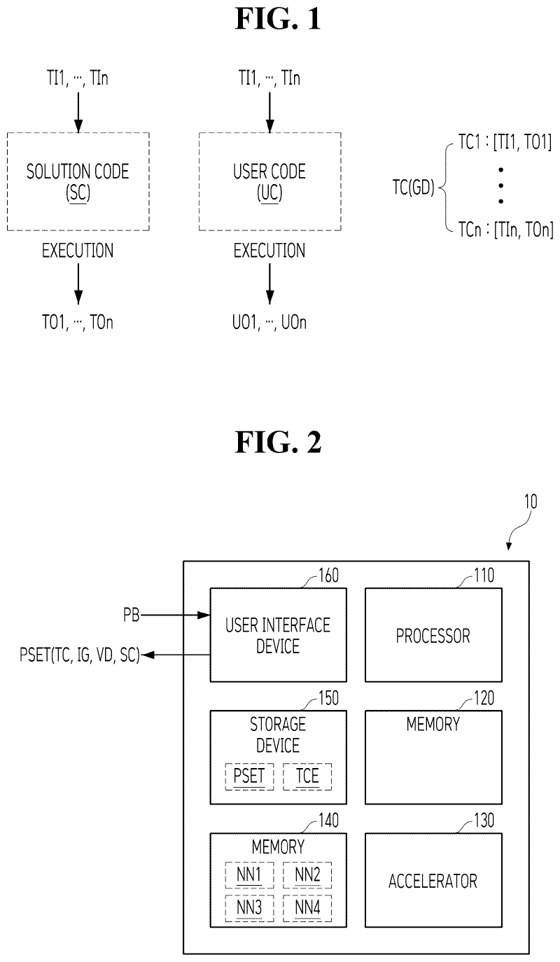

FIG. 1 is a diagram for describing a method of grading a user code written by a test subject and grading data.

Referring to FIG. 1, an evaluator may preset grading data GD, and the evaluator may grade and evaluate a user code UC written by a test subject based on a test case TC included in the grading data GD. The user code UC may include a source code, may be implemented in a programming language such as C language, Java, Python, Delphi, etc., and may be executed on a computing device, a processor, etc.

The grading data GD may include a plurality of first to nth test cases TC1 to TCn, and each of the first to nth test cases TC1 to TCn may include test input data and test output data. By way of example, referring to FIG. 1, the first test case TC1 may include first test input data TI1 and first test output data TO1, and the nth test case TCn may include nth test input data TIn and nth test output data TOn.

The test output data TO1 to TOn may be generated by executing a solution code SC which serves as a grading criterion for a problem. The solution code SC may include a source code, may be implemented in a programming language such as C language, Java, Python, Delphi, etc., and may be executed on a computing device, a processor, etc. By way of example, referring to FIG. 1, the solution code SC may be executed based on the first test input data TI1 to generate the first test output data TO1, and the solution code SC may be executed based on the nth test input data TIn to generate the nth test output data TOn.

The user code UC may be executed based on a plurality of test input data TI1 to TIn to generate user output data UO1 to UOn. First to nth user output data UO1 to UOn may correspond to the first to nth test input data TI1 to TIn, respectively, and the first to nth user output data UO1 to UOn may correspond to the first to nth test cases TC1 to TCn, respectively.

The evaluator may grade and evaluate the user code UC by comparing the first to nth user output data UO1 to UOn with the corresponding first to nth test cases TC1 to TCn.

Although not illustrated, the grading data GD may include memory restriction information or time restriction information, etc. The evaluator may measure a time when the first to nth user output data UO1 to UOn are output or a quantity of memory resources occupied when the user code UC is executed, and compare the measured time or memory resource quantity with the grading data GD to validate the user code UC.

FIG. 2 is a block diagram illustrating a device for generating grading data according to an embodiment.

Referring to FIG. 2, a grading data generation device 10 may receive a problem PB and generate a problem set PSET for the problem (PB) through an automatic process of a grading data generating method according to an embodiment of the present disclosure. According to an embodiment, the grading data generating device 10 may efficiently generate a test case TC for the problem PB through a grading data generating method using a plurality of neural networks.

The problem PB contains information about the problem PB, and the information may be expressed as a text, a formula, etc., which are natural languages. The problem set PSET may include a program code of an input data generator IG for grading a user code of a test subject, a program code of a validator VD, a solution code SC, and a test case TC.

The grading data generating device 10 may be implemented within a personal computer PC, a data server, or a hand-held device.

The hand-held device may be implemented as a laptop computer, a mobile phone, a smart phone, a tablet PC, a mobile internet device (MID), personal digital assistant (PDA), enterprise digital assistant (EDA), a digital still camera, a digital video camera, a portable multimedia player (PMP), a personal navigation device or portable navigation device (PND), a hand-held game console, an e-book, or a smart device. The smart device may be implemented as a smart watch, a smart band, or a smart ring.

The grading data generating device 10 may include a processor 110, a first memory 120, an accelerator 130, a second memory 140, a storage device 150, and a user interface device 160.

The grading data generating device 10 may receive the problem PB through the user interface device 160. The user interface device 160 may include a keyboard, a mouse, a pen, a voice input device, a touch input device, an infrared camera, a video input device, or any other input device, and may also include one or more displays, speakers, printers, any other output devices, or the like. In addition, the grading data generating device 10 may use an input device or output device provided in another computing device as the user interface device 160.

The processor 110 may generally control the grading data generating device 10. The processor 110 may execute at least one program stored in the first memory 120. By executing at least one program stored in the first memory 120 by the processor 110, the grading data generating device 10 may perform the grading data generating method of the present disclosure.

According to an embodiment, the processor 110 may execute at least one program to control components within the grading data generating device 10 to operate while the grading data generating device 10 performs an automatic process of the grading data generating method. For example, while the grading data generating device 10 performs the grading data generating method, the processor 110 may control the accelerator 130 to perform operations of neural networks NN1 to NN4 loaded into the second memory 140.

There may be one or more processors 110. One or more processors according to the present disclosure may include general-purpose processors including a central processing unit (CPU), a graphics processing unit (GPU), an accelerated processing unit (APU), a many integrated core (MIC), a digital signal processor (DSP), and a neural processing unit (NPU), or a dedicated processor for performing an operation method according to an embodiment of the present disclosure. One or more processors may be implemented in the form of an integrated system-on-chip (SoC) including one or more electronic components. Each of the one or more processors may be implemented as separate hardware H/W.

The processor 110 may receive the problem PB through the user interface device 160, and may control the accelerator 130 so that the accelerator 130 may generate problem information based on the problem PB. The problem PB may include a text, an equation, etc., which are natural languages, and the problem information may include a problem title, a problem description, an input format, an input restriction, an output format, an input/output example, restriction information, and the like for the problem PB. At least a portion of the problem information may define an input space of test input data for the problem PB.

The processor 110 may control the accelerator 130 so that the accelerator 130 may generate the input data generator IG for the problem PB based on the problem information. The input data generator IG may be implemented as a program code in one program.

The processor 110 may generate test input data for the problem PB by executing the input data generator IG. The grading data generating device 10 according to an embodiment may efficiently generate the test input data through the input data generator IG.

The processor 110 may control the accelerator 130 so that the accelerator 130 may generate a validator VD for the problem PB based on the problem information. The validator VD may be implemented as the program code in one program.

The processor 110 may execute the validator VD to verify validity of the test input data generated by the input data generator IG. The validator VD may verify whether the test input data is data included in an input space defined based on at least a portion of the problem information. The grading data generating device 10 according to an embodiment may generate reliable test input data through the validator VD.

The processor 110 may control the accelerator 130 so that the accelerator 130 may generate the solution code SC for the problem PB based on the problem information. The solution code (SC) may be implemented as the program code in one program.

The processor 110 may generate the test output data for the problem PB by executing the solution code SC based on the test input data for the problem PB. The test input data and the test output data corresponding to each other may be the test case TC of the problem PB.

The processor 110 may control the accelerator 130 so that the accelerator 130 performs a learning operation on a neural network based on the solution code SC and an external test case TCE input from outside. Through the learning operation of the external test case TCE and the solution code SC, the grading data generating device 10 according to an embodiment may generate a reliable solution code SC and test case TC.

The first memory 120 may store instructions (or programs) executable by the processor 110. For example, the instructions may include instructions for executing an operation of the processor 110 and/or an operation of each component of the processor 110. According to an embodiment, the first memory 120 may be operated as a system memory of the grading data generating device 10, and the first memory 120 may be connected to the processor 110 through a separate interface or a separate bus.

The first memory 120 may be implemented as a volatile memory device or a non-volatile memory device. The volatile memory device may be implemented as a dynamic random access memory (DRAM), a static random access memory (SRAM), a thyristor RAM (T-RAM), a zero capacitor RAM (Z-RAM), or a twin transistor RAM (TTRAM). The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

The accelerator 130 may perform operations on neural networks NN1 to NN4 loaded to the second memory 140. According to an embodiment, the accelerator 130 may perform operations on at least some layers within the neural networks NN1 to NN4 and may process matrix multiplication, convolution operations, or the like in parallel. The accelerator 130 may be, for example, a GPU, NPU, CPU, Field-Programmable Gate Array (FPGA), System-on-Chips (SoC), Application-Specific Integrated Circuits (ASIC), Vision Processing Units (VPU), neuromorphic IC, or the like, but is not limited thereto.

The accelerator 130 may include a plurality of multiply-accumulate units (MAC units) that may process data operations. A specification of the accelerator 130 may be determined based on the number of MAC units included in the accelerator 130. For example, when the number of MAC units is N, N parallel operations may be performed by the accelerator 130.

According to an embodiment, the accelerator 130 may perform at least some of the above-described operations of the processor 110 depending on a hardware type (e.g., CPU, etc.).

The second memory 140 may store one or more instructions and/or programs that allow the accelerator 130 to perform neural network operations. According to an embodiment, the first to fourth neural networks NN1 to NN4 may be stored in the second memory 140. According to an embodiment, the second memory 140 may be connected to the accelerator 130 through a separate interface or a separate bus.

The second memory 140 may be implemented as a volatile memory device or a non-volatile memory device. The volatile memory device may be implemented as a dynamic random access memory (DRAM), a static random access memory (SRAM), a thyristor RAM (T-RAM), a zero capacitor RAM (Z-RAM), or a twin transistor RAM (TTRAM). The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

The first memory 120 and the second memory 140 are illustrated as separate components in FIG. 2, but according to an embodiment, the first memory 120 and the second memory 140 may be implemented as a single memory device, and the memory implemented as a single memory device may support a memory pooling operation.

The first neural network NN1 may receive a problem PB and generate problem information for the problem PB. The first neural network NN1 may be a language model that performs natural language processing for a problem PB containing a text, an equation, etc., which are natural languages.

The first neural network NN1 may have a structure of an auto-regressive neural network that generates an output sequence for text tokens. The first neural network NN1 may repeat generating a specific token by reflecting a previously output text token into a context, and in this process, the first neural network NN1 may generate and sample a score distribution for text tokens conditioned on the context to generate a specific text token.

According to an embodiment, the first neural network NN1 may perform self-supervised learning based on an attention algorithm. According to an embodiment, the first neural network NN1 may include neural network structures such as Encoder-Decoder Transformer, Encoder only Transformer, Decoder only Transformer, Convolutional Neural Network (CNN), Long Short-Term Memory/Gated Recurrent Unit (LSTM/GRU), Recurrent Neural Network (RNN), etc.

The second neural network NN2 may receive the problem information for the problem PB and generate the input data generator IG for the problem PB. The second neural network NN2 may be a language model that performs natural language processing for problem information containing a text, an equation, etc., which are natural languages.

The second neural network NN2 may have a structure of an auto-regressive neural network that generates an output sequence for code tokens. The second neural network NN2 may repeat generating a specific token by reflecting a previously output code token into the context, and in this process, the second neural network NN2 may generate and sample a score distribution for code tokens conditioned on the context to generate a specific code token.

According to an embodiment, the second neural network NN2 may perform self-supervised learning based on the attention algorithm. According to an embodiment, the second neural network NN2 may include neural network structures such as Encoder-Decoder Transformer, Encoder only Transformer, Decoder only Transformer, CNN, LSTM/GRU, RNN, etc.

The third neural network NN3 may receive the problem information for the problem PB and generate the validator VD that verifies the validity of the test input data for the problem PB. The third neural network NN3 may be a language model that performs natural language processing for problem information containing a text, an equation, etc., which are natural languages.

The third neural network NN3 may have a structure of an auto-regressive neural network that generates an output sequence for code tokens. The third neural network NN3 may repeat generating a specific token by reflecting a previously output code token into the context, and in this process, the third neural network NN3 may generate and sample a score distribution for code tokens conditioned on the context to generate a specific code token.

According to an embodiment, the third neural network NN3 may perform self-supervised learning based on the attention algorithm. According to an embodiment, the third neural network NN3 may include neural network structures such as Encoder-Decoder Transformer, Encoder only Transformer, Decoder only Transformer, CNN, LSTM/GRU, RNN, etc.

The fourth neural network NN4 may receive the problem information for the problem PB and generate the solution code SC for the problem PB. The fourth neural network NN4 may be a language model that performs natural language processing for problem information containing a text, an equation, etc., which are natural languages.

The fourth neural network NN4 may have a structure of an auto-regressive neural network that generates an output sequence for code tokens. The fourth neural network NN4 may repeat generating a specific token by reflecting a previously output code token into the context, and in this process, the fourth neural network NN4 may generate and sample a score distribution for code tokens conditioned on the context to generate a specific code token.

According to an embodiment, the fourth neural network NN4 may perform self-supervised learning based on the attention algorithm. According to an embodiment, the fourth neural network NN4 may include neural network structures such as Encoder-Decoder Transformer, Encoder only Transformer, Decoder only Transformer, CNN, LSTM/GRU, RNN, etc.

According to an embodiment, the fourth neural network NN4 may perform learning operations based on the solution code SC, and the external test case TCE stored in the storage device 150. Based on the learning operations for the solution code SC and the external test case TCE, the fourth neural network NN4 may generate a reliable solution code SC.

The second neural network NN2 to the fourth neural network NN4 may be neural networks transfer-learned separately from one another, respectively, based on a pre-trained neural network, but are not limited thereto. In FIG. 2, the second neural network NN2 to the fourth neural network NN4 are illustrated as neural networks distinct from one another, but according to an embodiment, the second neural network NN2 to the fourth neural network NN4 may be implemented as a single neural network.

The storage device 150 may store one or more instructions and/or programs that are processed by the processor 110 and the accelerator 130, and according to an embodiment, the storage device 150 may store the problem set PSET and the external test case TCE.

According to an embodiment, the storage device 150 may include a non-volatile storage medium. For example, the storage device 150 may include at least one storage medium of a flash memory, a hard disk, a multimedia micro card, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

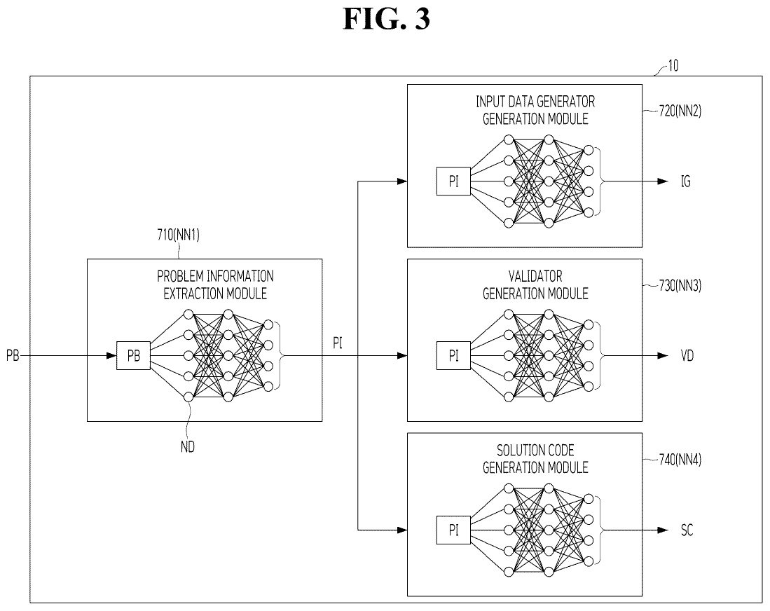

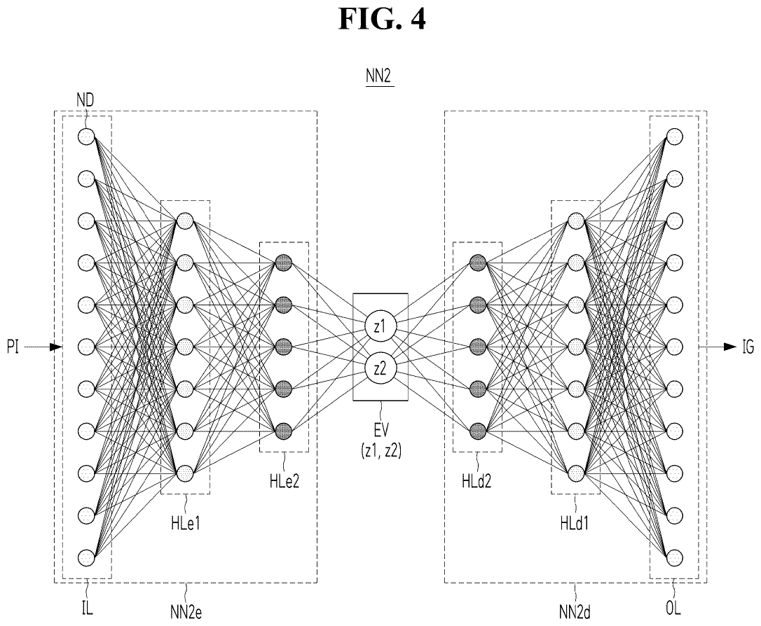

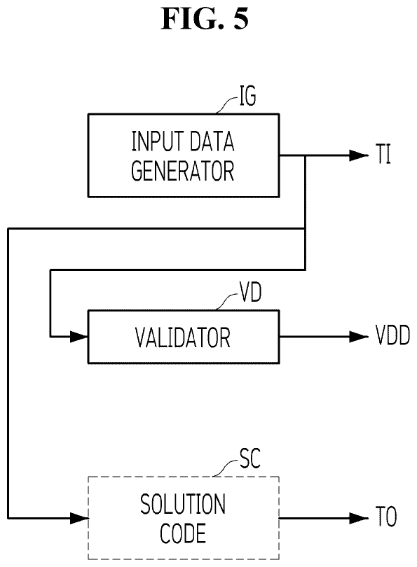

FIG. 3 is a block diagram illustrating a system for generating grading data according to an embodiment. FIG. 4 is a diagram for describing an exemplary structure of a language model neural network according to an embodiment. FIG. 5 is a diagram for describing an input data generator, a validator, and a solution code according to an embodiment.

Referring to FIGS. 3 to 5, the grading data generating device 10 may include a problem information extraction module 710, an input data generator generation module 720, a validator generation module 730, and a solution code generation module 740. The problem information extraction module 710, the input data generator generation module 720, the validator generation module 730, and the solution code generation module 740 of the grading data generating device 10 are modules in the grading data generating system implemented by the grading data generating device 10. The problem information extraction module 710, the input data generator generation module 720, the validator generation module 730, and the solution code generation module 740 of the grading data generating device 10 may interact with one another in an automatic process of the grading data generating method, and efficiently generate reliable test input data TI and test output data TO.

The problem information extraction module 710, the input data generator generation module 720, the validator generation module 730, and the solution code generation module 740 may be implemented by the processor 110 and the accelerator 130 of FIG. 2, or by programs loaded to the first and second memories 120 and 140 of FIG. 2, or by a combination of the processor 110 and the accelerator 130, and the loaded programs.

The problem information extraction module 710 may generate problem information PI based on the problem PB. The problem PB may include a text, an equation, etc., which are natural languages, and the problem information PI may include a problem title, a problem description, an input format, an input restriction, an output format, an input/output example, restriction information, and the like for the problem PB. The problem information PI may include a text, an equation, etc., which are natural languages. The grading data generating device 10 according to the present disclosure may, through the extracted problem information PI, induce the input data generator generation module 720, the validator generation module 730, and the solution code generation module 740 to generate a program code through a logical thinking process.

The problem information extraction module 710 may include a language model neural network, and the language model neural network may correspond to the first neural network NN1 of FIG. 2. According to an embodiment, the problem information extraction module 710 may include neural network structures such as Encoder-Decoder Transformer, Encoder only Transformer, Decoder only Transformer, CNN, LSTM/GRU, RNN, etc.

The first neural network NN1 of the problem information extraction module 710 may include at least one or more nodes NDs. The nodes NDs included in the first neural network NN1 of the problem information extraction module 710 may be interconnected by one or more links.

In the first neural network NN1 of the problem information extraction module 710 according to an embodiment, the one or more nodes NDs connected through links may relatively form a relationship of an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are interconnected to one output node by the respective links, the output node may determine an output node value based on values input in the input nodes connected with the output node and the weights set in the links corresponding to the respective input nodes.

In the first neural network NN1 of the problem information extraction module 710, one or more nodes NDs are interconnected through one or more links to form an input node and output node relationship. A characteristic of the neural network may be determined according to the number of nodes NDs, the number of links, correlations between the nodes NDs and the links, and values of the weights, granted to the respective links, in the neural network.

The first neural network NN1 of the problem information extraction module 710 may include an input layer, a hidden layer, and an output layer. Each of the input layer, the hidden layer, and the output layer may include at least one node ND.

The input data generator generation module 720 may generate the input data generator IG for the problem PB based on the problem information PI.

According to an embodiment, the input data generator IG may include a program code executable by the processor 110 of FIG. 2, and may generate the test input data TI for the problem PB according to the execution of the input data generator IG. According to an embodiment, the generated test input data TI may include test input data of a basic test case, test input data of a maximum size test case, test input data of a minimum size test case, and test input data of an edge test case. The edge test case may include test input data including negative numbers, duplicate values, and sorted data.

The input data generator generation module 720 may include a language model neural network, and the language model neural network may correspond to the second neural network NN2 of FIG. 2. According to an embodiment, the second neural network NN2 of the input data generator generation module 720 may include an encoder module and a decoder module.

According to an embodiment, the encoder module of the input data generator generation module 720 may encode tokenized problem information PI into an embedding vector. According to an embodiment, the decoder module of the input data generator generation module 720 may perform self-attention and cross-attention based on the embedding vector and may update a hidden state of the decoder module, and may predict a code token of the input data generator IG output based on the updated hidden state through Softmax. According to an embodiment, the input data generator generation module 720 may output an output sequence for code tokens of the input data generator IG by using previously generated code tokens as an input context in an autoregressive scheme.

According to an embodiment, the decoder module of the input data generator generation module 720 may update the hidden state of the decoder module based on Equation 1 below.
[Equation 1]

[symbol] [0097] is a current hidden state vector of the decoder module, is an update weight matrix in the decoder module, is an immediately previous hidden state vector, is a query for the embedding vector output from the decoder module, is a key vector for the embedding vector output by the encoder module, is a value vector for the embedding vector output from the encoder module; and is a position information vector for a current code token that is currently output.

According to an embodiment, the decoder module of the input data generator generation module 720 may generate a probability distribution for a current output code within the program code of the input data generator IG based on Equation 2 below, and perform a sampling operation based on the generated probability distribution to generate a current output code.
[Equation 2]

[symbol] [0101] is a current code token for a current output code within the program code of the input data generator IG, is a previous code token for an immediately previous output code in the program code of the input data generator IG, is problem information, is an output weight matrix for the decoder module, and is a current hidden state vector of the decoder module.

According to an embodiment, the second neural network NN2 of the problem information extraction module 720 may include neural network structures such as Encoder-Decoder Transformer, Encoder only Transformer, Decoder only Transformer, CNN, LSTM/GRU, RNN, etc.

The second neural network NN2 of the input data generator generation module 720 may include at least one or more nodes NDs. The second neural network NN2 of the input data generator generation module 720 may include the plurality of nodes and layers described above in the problem information extraction module 710.

By way of example, referring to FIG. 4, the second neural network NN2 may include an encoder module NN2e and a decoder module NN2d.

The encoder module NN2e may include an input layer IL and encoding hidden layers HLe1 and HLe2, and the decoder module NN2d may include decoding hidden layers HLd1 and HLd2 and an output layer OL.

The nodes NDs included in the input layer IL may mean one or more nodes NDs, among the nodes NDs within the second neural network NN2, to which the tokenized problem information PI is directly input without going through a link in relation to the other nodes. Alternatively, the nodes NDs may mean nodes NDs that do not have other input nodes connected by a link in a relationship between nodes based on links within the second neural network NN2.

The nodes NDs included in the output layer OL may mean one or more nodes NDs, among the nodes NDs within the second neural network NN2, that do not have an output node in relation to the other nodes.

According to an embodiment, the encoder module NN2e may have an encoder structure and the number of nodes NDs may decrease by proceeding from the input layer IL to the encoding hidden layers HLe1 and HLe2. According to an embodiment, a second encoding hidden layer HLe2 may output an embedding vector EV. According to an embodiment, the embedding vector EV may be referred to as an encoded code vector of the encoder module NN2e.

The embedding vector EV as data having two-dimensional data may include elements z1 and z2. A data type of each of z1 and z2 may be any one of a numerical type including integer/real number types, a character type, and a set type, but the dimensions and the number of elements of the embedding vector EV and a data type of each element are merely examples for description and do not limit the technical scope of the present disclosure.

According to an embodiment, the embedding vector EV may be input into a second decoding hidden layer HLd2 of the decoder module NN2d. The decoder module NN2d may have a decoder structure and the number of nodes NDs may increase by proceeding from the decoding hidden layers HLd2 and HLd1 to the output layer OL. According to an embodiment, the output layer OL may output the code token for the input data generator IG.

Although not illustrated, the input data generator generation module 720 may further include a Chain of Thought (COT) module that reconstructs an input prompt for the input problem information PI. The input data generator generation module 720 may include a logical thinking process in the prompt input through the COT module. According to an embodiment, the COT module may be a neural network or a function module.

The validator generation module 730 may generate the validator VD for the problem PB based on the problem information PI.

According to an embodiment, the validator VD may include a program code executable by the processor 110 of FIG. 2, and may verify validity of the test input data T1 for the problem PB and output validity decision data VDD according to the execution of the validator VD. The validator VD may verify the validity of the test input data TI by verifying whether the test input data TI may be included in the input space defined based on at least a portion of the problem information PI.

The validator generation module 730 may include a language model neural network, and the language model neural network may correspond to the third neural network NN3 of FIG. 2. According to an embodiment, the third neural network NN3 of the validator generation module 730 may include an encoder module and a decoder module. According to an embodiment, the encoder module and the decoder module of the third neural network NN3 may correspond to the encoder module and the decoder module of the second neural network NN2, respectively, and hereinafter, for ease of description, the description of the encoder module and the decoder module of the third neural network NN3 is replaced with the aforementioned description of the encoder module and the decoder module of the second neural network NN2.

According to an embodiment, the encoder module of the validator generation module 730 may encode tokenized problem information PI into the embedding vector. According to an embodiment, the decoder module of the validator generation module 730 may perform self-attention and cross-attention based on the embedding vector and may update a hidden state of the decoder module, and may predict a code token of the validator VD output based on the updated hidden state through Softmax. According to an embodiment, the validator generation module 730 may output an output sequence for code tokens of the validator VD by using previously generated code tokens as an input context in the autoregressive scheme.

Although not illustrated, the validator generation module 730 may further include a Chain of Thought (COT) module that reconstructs an input prompt for the input problem information PI. The validator generation module 730 may include a logical thinking process in the prompt input through the COT module.

The solution code generation module 740 may generate a solution code SC for the problem PB based on the problem information PI.

According to an embodiment, the solution code SC may include a source code that serves as a grading criterion for the problem PB, and may include a program code executable by the processor 110 of FIG. 2. According to the execution of the solution code SC based on the test input data TI, the test output data TO for the problem PB may be generated.

The solution code generation module 740 may include a language model neural network, and the language model neural network may correspond to the fourth neural network NN4 of FIG. 2. According to an embodiment, the fourth neural network NN4 of the solution code generation module 740 may include an encoder module and a decoder module. According to an embodiment, the encoder module and the decoder module of the fourth neural network NN4 may correspond to the encoder module and the decoder module of the second neural network NN2, respectively, and hereinafter, for ease of description, the description of the encoder module and the decoder module of the fourth neural network NN4 is replaced with the aforementioned description of the encoder module and the decoder module of the second neural network NN2.

According to an embodiment, the encoder module of the solution code generation module 740 may encode the tokenized problem information PI into the embedding vector. According to an embodiment, the decoder module of the solution code generation module 740 may perform self-attention and cross-attention based on the embedding vector and may update a hidden state of the decoder module, and may predict a code token of the solution code SC output based on the updated hidden state through Softmax. According to an embodiment, the solution code generation module 740 may output an output sequence for code tokens of the solution code SC by using previously generated code tokens as an input context in the autoregressive scheme.

Although not illustrated, the solution code generation module 740 may further include a Chain of Thought (COT) module that reconstructs an input prompt for the input problem information PI. The solution code generation module 740 may include a logical thinking process in the prompt input through the COT module.

The grading data generating system according to the present disclosure may efficiently generate reliable test input data TI and test output data TO through the problem information extraction module 710, the input data generator generation module 720, the validator generation module 730, and the solution code generation module 740.

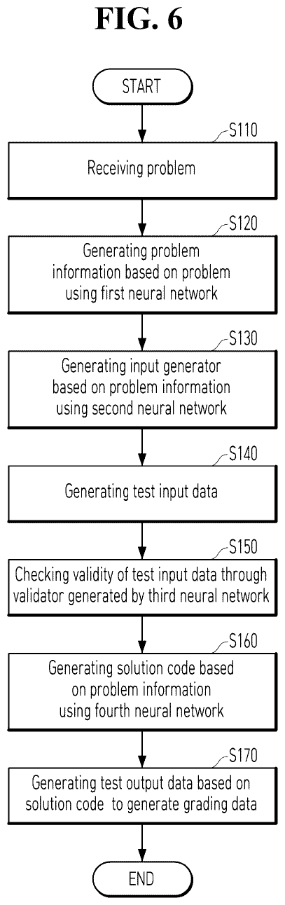

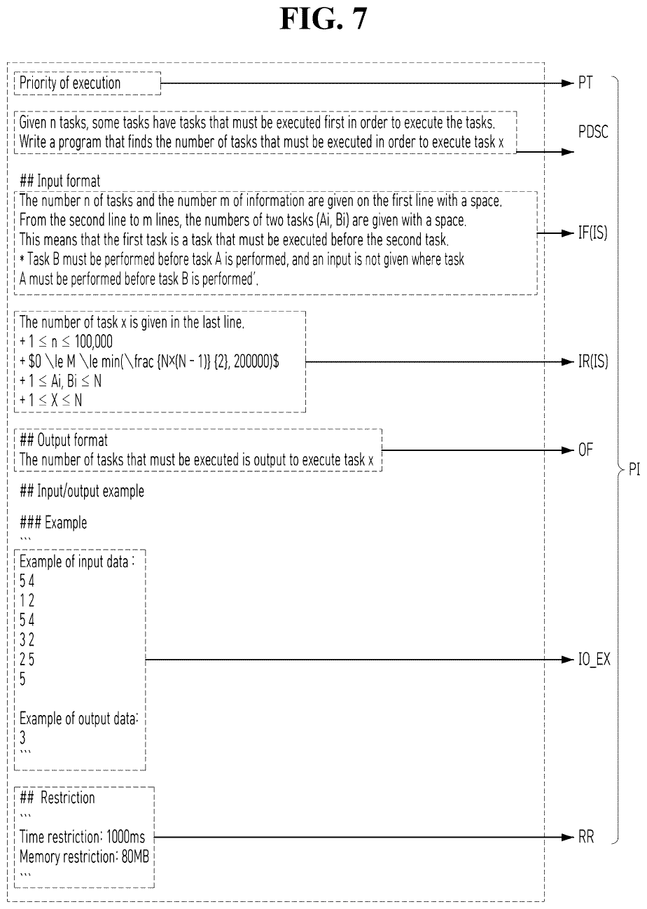

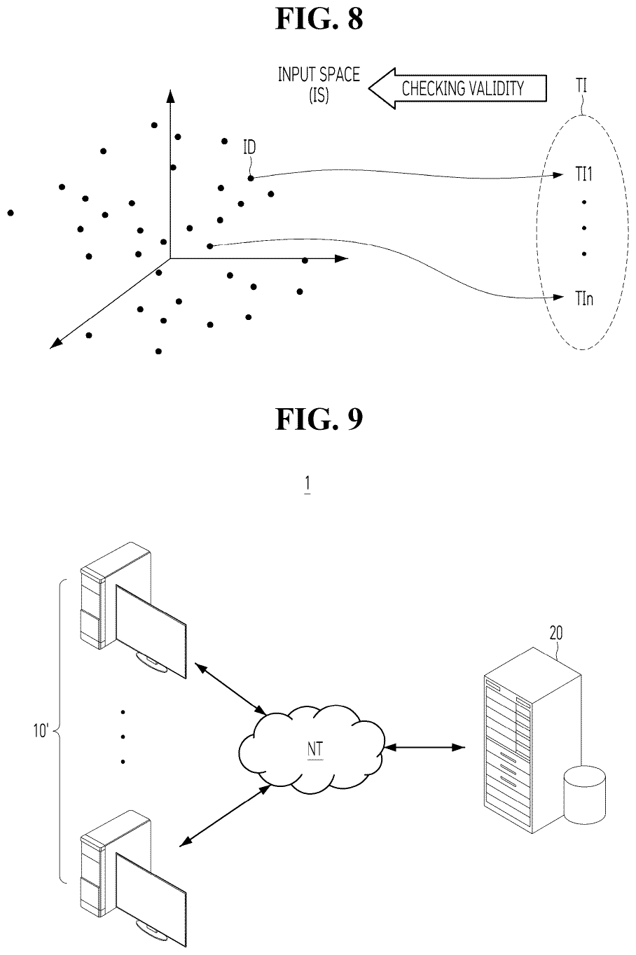

FIG. 6 is a flowchart illustrating a method for generating grading data according to an embodiment. FIGS. 7 and 8 are diagrams for describing a method for generating grading data according to an embodiment. Specifically, FIG. 7 illustrates an example of a problem PB and a plurality of problem information PT for the problem PB, and FIG. 8 illustrates a relationship of an input space IS and test input data T1.

Referring to FIGS. 3, 5, and 6, the problem information extraction module 710 receives the problem PB (S110).

According to an embodiment, the problem information extraction module 710 may receive the problem PB through the storage device 150 or the user interface device 160 of FIG. 2. The problem PB may include a text, an equation, etc., which are natural languages.

The problem information extraction module 710 generates the plurality of problem information PI based on the problem PB using the first neural network NN1 (S120).

By way of example, referring to FIG. 7, the problem information extraction module 710 may generate the plurality of problem information PI from the problem PB. The plurality of problem information PI may include a problem title PT, a problem description PDSC, an input format IF, an input restriction IR, an output format OF, an input/output example IO_EX, and restriction information RR. The plurality of problem information PI may include a text, an equation, etc., which are natural languages.

The problem title PT may mean a title of the problem PB, and by way of example, referring to FIG. 7, the problem title PT may include ‘priority of execution’.

The problem description PDSC includes information about an execution purpose of a user code or a solution code written by a test subject, and by way of example, referring to FIG. 7, the problem description PDSC may include ‘Given n tasks, some tasks have tasks that must be executed first in order to execute the tasks. Write a program that finds the number of tasks that must be executed in order to execute task x’.

The input format IF means the format of data input to the user code or solution code SC, and by way of example, referring to FIG. 7, the input format IF may include ‘The number n of tasks and the number m of information are given on the first line with a space. From the second line to m lines, the numbers of two tasks (Ai, Bi) are given with a space. This means that the first task is a task that must be executed before the second task. * Task B must be performed before task A is performed, and an input is not given where task A must be performed before task B is performed’. According to an embodiment, the input format IF may be information defining the input space IS of input data for the problem PB.

The input restriction IR means restriction information of data that is input into the user code or solution code SC, and by way of example, referring to FIG. 7, the input restriction IR may include: ‘The number of task x is given in the last line: +1≤n≤100,000; +$0 \le M \le Min(\frac {N×(N−1)}{2}, 200000)$; +1≤Ai, Bi≤N ; +1≤X≤N’. According to an embodiment, the input restriction IR may be information defining the input space IS of the input data for the problem PB.

The output format OF means a format of data output to the user code or solution code SC, and by way of example, referring to FIG. 7, the output format OF may include: ‘The number of tasks that must be executed is output to execute task x’.

The input/output example IO_EX may mean an example of data that is input and output when user code or solution code SC is executed.

The restriction information RR may mean restriction information according to the execution of the user code or solution code SC. According to an embodiment, the restriction information RR may be problem information PI and may include memory restriction information, time restriction information, and the like.

A plurality of problem information PI for a generated problem PB may be provided to the input data generator generation module 720, the validator generation module 730, and the solution code generation module 740. Separately distinguished problem information PI may facilitate the logical thinking process of the input data generator generation module 720, the validator generation module 730, and the solution code generation module 740.

The input data generator generation module 720 generates an input data generator IG based on the problem information PI using the second neural network NN2 (S130).

According to an embodiment, the input data generator generation module 720 may generate the input data generator IG based on at least one of the input format IF and the input restriction IR of the problem information PI.

The input data generator IG generates test input data TI (S140).

Through the execution of the input data generator IG, the input data generator IG may select test input data TI from the input space for the problem PB. According to an embodiment, the input space for the problem PB may be defined based on at least one of the input format IF and the input restriction IR of the problem information PI.

By way of example, referring to FIG. 8, the input data generator IG may select a plurality of test input data TI1 to TIn from the input data ID of the input space IS defined based on the problem information PI. The plurality of test input data TI1 to TIn may include test input data of a basic test case, test input data of a maximum size test case, test input data of a minimum size test case, and test input data of an edge test case.

The validator VD generated by the third neural network NN3 verifies the validity of the test input data TI (S150).

The validator generation module 730 may generate the validator VD based on the problem information PI by using the third neural network NN3. According to an embodiment, the validator generation module 730 may generate the validator VD based on at least one of the input format IF and the input restriction IR of the problem information PI.

The validator VD may be executed based on the test input data TI generated by the input data generator IG. The validator VD may verify whether the test input data TI is included in the input space for the problem PB. The validator VD may verify the validity of the test input data TI by verifying whether the test input data TI is included in the input space, and output validation decision data VDD for the test input data TI according to a verification result.

By way of example, referring to FIG. 8, the validator VD may verify whether a plurality of test input data TI1 to TIn are the input data ID of the input space IS. According to a verification result, the validator VD may output the validation decision data VDD for the plurality of test input data TI1 to TIn.

The solution code generation module 740 generates the solution code SC based on the problem information PI using the fourth neural network NN4 (S160).

The test output data TO is generated through the execution of the solution code SC based on the test input data TI to generate grading data (S170).

According to an embodiment, the processor 110 of FIG. 2 may execute the solution code SC based on the test input data TI of which validity is verified to generate the test output data TO for the test input data TI.

According to an embodiment, the test input data TI and the test output data TO that correspond to each other may be one test case TC and may be grading data.

The grading data generating method according to the present disclosure may efficiently generate reliable grading data through steps S110, S120, S130, S140, S150, S160, and S170. According to an embodiment, steps S110, S120, S130, S140, S150, S160, and S170 may be performed automatically, and each of steps S110, S120, S130, S140, S150, S160, and S170 may be a logical thinking step of Chain of Thought. According to an embodiment, steps S110, S120, S130, S140, S150, S160, and S170 of the grading data generating method may be performed automatically, and the grading data may be generated automatically according to provision of the problem PB.

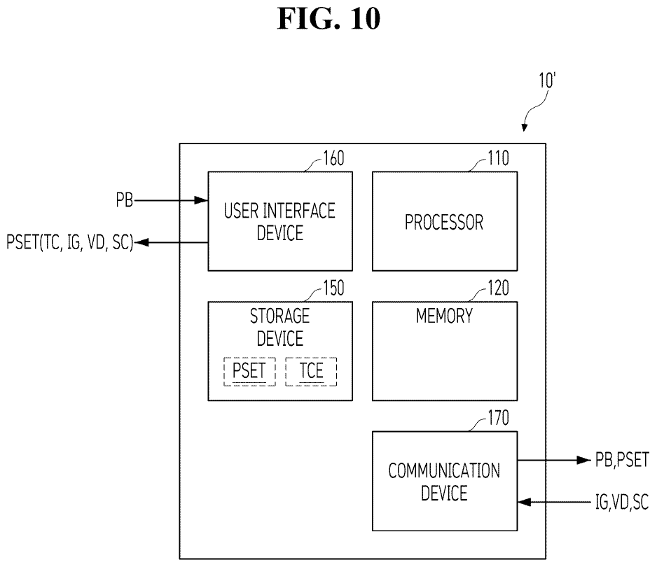

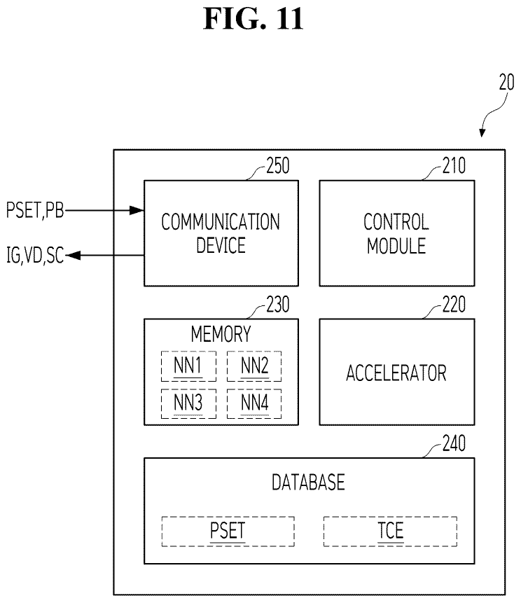

FIGS. 9 to 11 are diagrams illustrating a system for generating grading data according to an embodiment. The grading data generation system 1 of FIGS. 9 to 11 may correspond to the grading data generating system implemented in the grading data generating device 10 of FIGS. 2 and 3.

Hereinafter, for ease of description, the grading data generating system 1 of FIGS. 9 to 11 will be described based on differences from the grading data generating system of FIGS. 2 and 3.

Referring to FIGS. 9 to 11, the grading data generating system 1 may include a terminal 10′ and a server 20.

The terminal 10 and the server 20 may be connected via a network NT. As illustrated in FIG. 9, at least one terminal 10′ may be connected to the server 20 through the network NT. The server 20 may be connected to at least one terminal 10′ via the network NT.

Here, the network means a connection structure in which information exchange is enabled among respective nodes such as a plurality of terminals and servers, and examples of the network include a Local Area Network (LAN), a Wide Area Network (WAN), a World Wide Web (WWW), a wired and wireless data network, a telephone network, a wired and wireless television network, and the like. Examples of the wireless communication network include 3G, 4G, 5G, 3rd Generation Partnership Project (3GPP), 5th Generation Partnership Project (5GPP), Long Term Evolution (LTE), World Interoperability for Microwave Access (WIMAX), Wi-Fi, Internet, Local Area Network (LAN), Wireless Local Area Network (LAN), Wide Area Network (WAN), Personal Area Network (PAN), radio frequency (RF), Bluetooth network, Near-Field Communication (NFC) network, satellite broadcasting network, analog broadcasting network, Digital Multimedia Broadcasting (DMB) network, and the like, etc., but are not limited thereto.

The terminal 10′ may provide the server 20 with a problem PB as a request, receive an input data generator IG, a validator VD and a solution code SC, as a response to the problem PB, from the server 20, and execute the input data generator IG, the validator VD, and the solution code SC. The terminal 10′ may provide the server 20 with a test case TC and a problem set PSET, which are execution results on the input data generator IG, the validator VD, and the solution code SC.

The terminal 10′ may include a processor 110, a first memory 120, a storage device 150, a user interface device 160, and a communication device 170. The processor 110, the first memory 120, the storage device 150, and the user interface device 160 may correspond to the processor 110, the first memory 120, the storage device 150 and the user interface device 160 in FIG. 2, respectively.

The communication device 170 enables the terminal 10′ to communicate with the server 20 corresponding to another computing device or another terminal 10'. According to an embodiment, the terminal 10′ may provide the server 20 with the problem PB and the problem set PSET through the communication device 170 and may receive the input data generator IG, the validator VD, and the solution code SC from the server 20. The communication device 170 may include a modem, a network interface card (NIC), an integrated network interface, a radio frequency transmitter/receiver, an infrared port, a USB connection, or another interface for connecting the computing device to another computing device. The communication device 170 may be connected to another computing device through a wired connection or a wireless connection.

The server 20 may include a control module 210, an accelerator 220, a second memory 230, a database 240, and a communication device 250. The accelerator 220 and the second memory 230 may correspond to the accelerator 130 and the second memory 140 of FIG. 2, respectively.

According to an embodiment, the first to fourth neural networks NN1 to NN4 may be loaded into the second memory 230 to perform learning and inference operations. According to an embodiment, the first to fourth neural networks NN1 to NN4 may generate problem information, a program code of the input data generator IG, a program code of the validator VD, and the solution code SC, respectively.

The control module 210 may control overall operations of components within the server 20. The control module 210 may include a control program (or instruction) that enables performing such control operations, a non-volatile memory in which the control program is installed, a volatile memory in which at least part of the installed control program is loaded, and at least one processor or central processing unit (CPU) for executing the loaded control program. Further, the control program may be stored in another external electronic device or computer-readable recording medium in addition to the server 20.

The control program may include a program(s) implemented in at least one form of a BIOS, a device driver, an operating system, firmware, a platform, and an application program (application). In an embodiment, the application program may be pre-installed or stored in the service providing server 20 during manufacture of the server 20, or may be installed in the server 20 based on received data upon receiving data of the application program from the outside during subsequent use. The data of the application program may be downloaded from an external server such as an application market, for example, but the downloading is not limited thereto. Meanwhile, the control module 210 may be implemented in the form of a device, a S/W module, a circuit, a chip, or a combination thereof.

The control module 210 may control the operations of the components within the server 20 in response to a request provided from the terminal 10′.

The database 240 may store the problem set PSET and the external test case TCE. According to an embodiment, the problem set PSET and the external test case TCE may be stored in the database 240 for each problem PB by the terminal 10′ connected to the server 20 though the network NT. Further, the database 240 may store data received from the terminal 10′ and may also receive and store information such as detailed items for managing use of the application received by the control module 210.

The database 240 may store various data according to processing and control of the control module 210. The database 240 may be accessed by the control module 210 to perform reading, writing, modifying, deleting, updating, etc. of data. The database 240 may include a non-volatile memory such as a flash memory, a hard disk drive, an SSD (Solid-State Drive), etc., to preserve data regardless of whether system power is provided to the server 20. In addition, the database 240 may include a volatile memory such as a buffer, a RAM, etc., for temporarily loading data processed by the control module 210.

The communication device 250 may communicate with the terminal 10′ or other external electronic devices through a wired or wireless communication scheme. According to an embodiment, the server 20 may receive the problem PB and the problem set PSET from the terminal 10′ through the communication device 170 and may provide the terminal 10′ with the input data generator IG, the validator VD, and the solution code SC. Therefore, in addition to a connection unit including a connector or terminal for wired connection, the communication device may be implemented in various other communication schemes. For example, the communication device may be configured to perform one or more communications among Wi-Fi, Bluetooth, Zigbee, infrared communication, Radio Control, Ultra-Wide Band (UWB), Wireless USB, and Near Field Communication (NFC). The communication device 250 may include communication modules such as Bluetooth Low Energy (BLE), Serial Port Profile (SPP), Wi-Fi Direct, infrared communication, Zigbee, and Near Field Communication (NFC). Further, the communication device 250 may be implemented in the form of a device, a S/W module, a circuit, a chip, etc.

Further, it is apparent that each step or operations of the method according to an embodiment may be performed by a computer including one or more processors according to execution of a computer program stored on a computer-readable recording medium.

The computer-executable instructions stored in the aforementioned recording medium may be implemented through a computer program programmed to perform each corresponding step, and such computer program may be stored on a computer-readable recording medium and may be executed by a processor. The computer-readable recording medium may be a non-transitory readable medium. In this case, the non-transitory computer readable medium is not a medium that stores data therein for a while, such as a register, a cache, a memory, or the like, but means a medium that semi-permanently stores data therein and is readable by a device. Specifically, programs for performing the various methods described above may be stored and provided in non-transitory readable media such as semiconductor memory devices including erasable programmable read-only memory (EPROM), electrically erasable programmable read-only memory (EEPROM), and flash memory devices, magnetic disks such as internal hard disks and mobile disks, magneto-optical disks, and non-volatile memory including CD-ROM and DVD-ROM disks.

A method according to various examples disclosed in this document may be provided while being included in a computer program product. The computer program products may be distributed in the form of a device readable storage medium (e.g., compact disc read only memory (CD-ROM) or distributed online through an application store (e.g., Play Store™). In the case of online distribution, some of the computer program products may be at least transitorily stored in a storage medium such as a server of a manufacturer, a server of the application store, or a memory of a relay server, or temporarily generated.

As described above, those skilled in the art to which the present disclosure pertains will be able to understand that the present disclosure may be embodied in other specific forms without departing from its technical spirit or essential characteristics. Therefore, it should be understood that the above-described embodiments are illustrative in all aspects and do not limit the present disclosure. The scope of the present disclosure is represented by claims to be described below rather than the detailed description, and it is to be interpreted that the meaning and scope of the claims and all the changes or modified forms derived from the equivalents thereof come within the scope of the present disclosure.

The features and advantages described herein are not exhaustive, and in particular, many additional features and advantages will become apparent to those skilled in the art upon consideration of the drawings, specification, and claims. Moreover, it should be noted that the language used herein has been chosen primarily for readability and instructional purposes, and may not have been chosen to delineate or limit the subject matter of the present disclosure.

The foregoing description of embodiments of the present disclosure has been presented for purposes of illustration. It is not intended to be exhaustive or to limit the present disclosure to the precise forms disclosed. Those skilled in the art may appreciate that many modifications and variations are possible in light of the above disclosure.

Therefore, the scope of the present disclosure is not limited by the detailed description, but is limited by any claims of applications based thereon. Accordingly, the disclosure of the embodiments of the present disclosure is illustrative and does not limit the scope of the present disclosure as set forth in the following claims.

What is claimed is:

1. A method for generating grading data for a coding test, the method comprising:
receiving a problem through a user interface;
generating a plurality of problem information based on the problem using a first neural network;
generating an input data generator for the problem based on the plurality of problem information using a second neural network;
executing the input data generator to generate test input data for the problem;
generating a solution code for the problem based on the plurality of problem information using a third neural network; and
generating test output data for the test input data based on the solution code to generate the grading data.

2. The method of claim 1, wherein the problem includes a text which is a natural language, and
the first neural network is a language model configured to perform natural language processing.

3. The method of claim 1, wherein at least some of the plurality of problem information includes a text which is a natural language, and
the second neural network is configured to output a program code of the input data generator based on the plurality of problem information.

4. The method of claim 1, wherein the plurality of problem information includes at least one of a problem description, an input format, an input restriction, an output format, an input/output example, and restriction information for the problem.

5. The method of claim 1, wherein the second neural network includes an encoder module configured to generate an embedding vector based on the plurality of problem information and a decoder module configured to generate the input data generator based on the embedding vector.

6. The method of claim 1, wherein the generating of the grading data includes executing the solution code to generate the test output data based on the test input data.

7. The method of claim 1, further comprising:
verifying validity of the test input data through a validator generated based on a fourth neural network.

8. The method of claim 7, wherein the validator is generated through the fourth neural network based on the plurality of problem information.

9. The method of claim 7, wherein the second neural network, the third neural network, and the fourth neural network are transfer-learned separately from one another.

10. The method of claim 9, wherein the third neural network is trained based on the solution code and a prestored test case.

11. A device for generating grading data, the device comprising:
a processor;
an accelerator; and
a memory,
wherein the processor is configured to execute a program stored in the memory to perform:
receiving a problem through a user interface;
generating a plurality of problem information based on the problem using a first neural network computed by the accelerator;
generating an input data generator for the problem based on the plurality of problem information using a second neural network computed by the accelerator;
executing the input data generator to generate test input data for the problem;
generating a solution code for the problem based on the plurality of problem information using a third neural network computed by the accelerator; and
generating test output data for the test input data based on the solution code to generate the grading data.

12. The device of claim 11, wherein the problem includes a text which is a natural language,
at least some of the plurality of problem information includes a text which is a natural language, and
the first neural network is a language model configured to perform natural language processing.

13. The device of claim 11, wherein the plurality of problem information includes at least one of a problem description, an input format, an input restriction, an output format, an input/output example, and restriction information for the problem.

14. The device of claim 11, wherein the second neural network includes an encoder module configured to generate an embedding vector based on the plurality of problem information and a decoder module configured to generate the input data generator based on the embedding vector.

15. The device of claim 11, wherein the processor is further configured to verify validity of the test input data through a validator generated based on a fourth neural network, and
the validator is generated through the fourth neural network based on the plurality of problem information.

16. The device of claim 15, wherein the second neural network, the third neural network, and the fourth neural network are transfer-learned separately from one another.

17. The device of claim 16, wherein the third neural network is trained based on the solution code and a prestored test case.

18. A system for generating grading data, the system comprising:
a problem information extraction module configured to receive a problem and generate a plurality of problem information based on the problem;
an input data generator generation module configured to generate an input data generator configured to generate test input data for the problem based on the plurality of problem information;
a validator generation module configured to generate a validator verifying validity of the test input data based on the plurality of problem information; and
a solution code generation module configured to generate a solution code for the problem based on the plurality of problem information.

19. The system of claim 18, wherein the input data generator generation module includes a first neural network,
the validator generation module includes a second neural network,
the solution code generation module includes a third neural network, and
the first to third neural networks are transfer-learned separately from one another.

20. The system of claim 18, wherein the solution code is executed to generate test output data for the test input data based on the test input data.
